(19) United States
(12) Patent Application Publication
(10) Pub. No.: US 2011/0279394 A1
(43) Pub. Date: Nov. 17, 2011

(54) TOUCH SCREEN PANEL STRUCTURE OF MOBILE DEVICE

(75) Inventor: Tae Sung KIM, Seoul (KR)

(73) Assignee: SAMSUNG ELECTRONICS CO. LTD., Suwon-si (KR)

(21) Appl. No.: 13/100,433

(22) Filed: May 4, 2011

(30) Foreign Application Priority Data
May 12, 2010 (KR) 10-2010-0044341

(51) Int. Cl. G06F 3/041

(52) U.S. Cl. 345/173

(57) ABSTRACT

A Touch Screen Panel (TSP) structure of a mobile device is provided. The TSP structure includes a TSP and a Light Emitting Diode (LED). The TSP includes a transparent substrate and at least one indium tin oxide (ITO) film stacked on the transparent substrate. The transparent substrate includes an icon display source formed on a lower surface thereof. The ITO film has an electrode line formed on a lower surface or an upper surface thereof. The LED is located near a lateral side of the transparent substrate. In the TSP structure, the icon display source scatters the light of the LED and thereby allowing an icon to be displayed on a screen with reduced electric power.

### PRIORITY

This application claims the benefit under 35 U.S.C. §119(a) of a Korean patent application filed on May 12, 2010 in the Korean Intellectual Property Office and assigned Serial No. 10-2010-0044341, the entire disclosure of which is hereby incorporated by reference.

### BACKGROUND OF THE INVENTION

1. Field of the Invention

The present invention relates to a Touch Screen Panel (TSP) structure of a mobile device. More particularly, the present invention relates to a TSP structure in which an icon display source formed on a transparent substrate scatters light of a Light Emitting Diode (LED) and thereby allows an icon to be displayed on a screen.

2. Description of the Related Art

Recently, touch screen technology has been widely applied to a mobile device, also referred to as a portable terminal, and the like, in order to increase a display area in the mobile device with a limited size while reducing the weight and thickness of the mobile device. Normally, the touch screen technology is implemented by means of a Touch Screen Panel (TSP) and a main Liquid Crystal Display (LCD) disposed under the TSP.

When displaying an icon on the screen, the mobile device having a conventional TSP enables the main LCD to represent the icon in a software manner. Namely, it is required to drive the main LCD in order to merely display a small icon on the screen. However, as compared with the size of an icon displayed, the driving of the main LCD needs excessive electric power and thus causes a waste of electric power.

### SUMMARY OF THE INVENTION

An aspect of the present invention is to address the above-mentioned problems and/or disadvantages and to provide at least the advantages described below. Accordingly, an aspect of the present invention is to provide a touch screen panel structure of a mobile device for providing a reduction of electric power required for displaying an icon on a screen of the mobile device.

In accordance with an aspect of the present invention, a touch screen panel structure of a mobile device is provided. The structure includes a touch screen panel including a transparent substrate and at least one indium tin oxide (ITO) film stacked on the transparent substrate, the transparent substrate includes an icon display source formed on a lower surface thereof, and the ITO film includes an electrode line formed on a lower surface or an upper surface thereof, and a Light Emitting Diode (LED) located near a lateral side of the transparent substrate.

In accordance with another aspect of the present invention, a touch screen panel structure of a mobile device is provided. The structure includes a touch screen panel including a transparent substrate and at least one ITO film stacked on the transparent substrate, the transparent substrate comprising an icon display source formed on a lower surface thereof, and a first ITO film and a second ITO film each comprising electrode lines formed on a lower surface or an upper surface thereof, an LED located near a lateral side of the transparent substrate, and an icon sheet formed on the second ITO film for protecting the touch screen panel and for displaying an icon.

Since the icon display source is formed on a lower surface of the transparent substrate and the LED is adjacent to the icon display source, the amount of electric power consumed for displaying an icon on the screen may be reduced.

Additionally, since an LED is used for an icon display, the production cost of the mobile device may be reduced in comparison with using conventional dot LEDs.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a mobile device including a Touch Screen Panel (TSP) structure according to an exemplary embodiment of the present invention.

FIG. 2 is a cross-sectional view taken along a dotted line B-B′ of a mobile device including a TSP structure according to an exemplary embodiment of the present invention.

FIG. 3 illustrates a transparent substrate in a TSP structure of a mobile device according to an exemplary embodiment of the present invention.

FIG. 4 illustrates an icon displayed on a screen by an operation of a TSP structure of a mobile device according to an exemplary embodiment of the present invention.

FIG. 5 illustrates an icon displayed on a screen by an operation of a TSP structure of a mobile device according to another exemplary embodiment of the present invention.

Throughout the drawings, it should be noted that like reference numbers are used to depict the same or similar elements, features, and structures.

### DETAILED DESCRIPTION EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

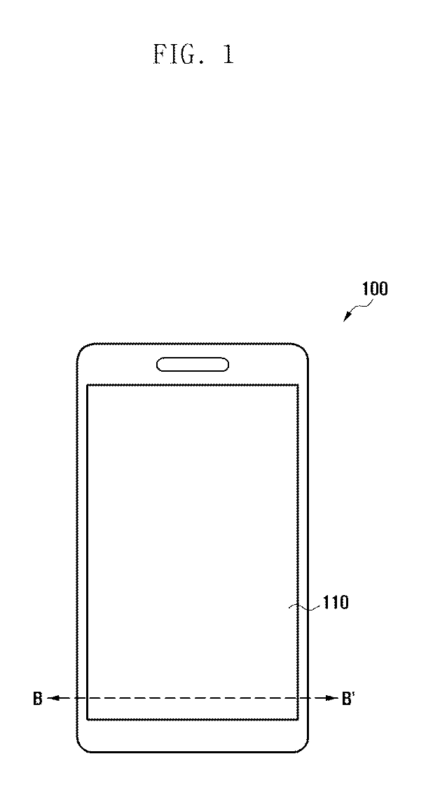

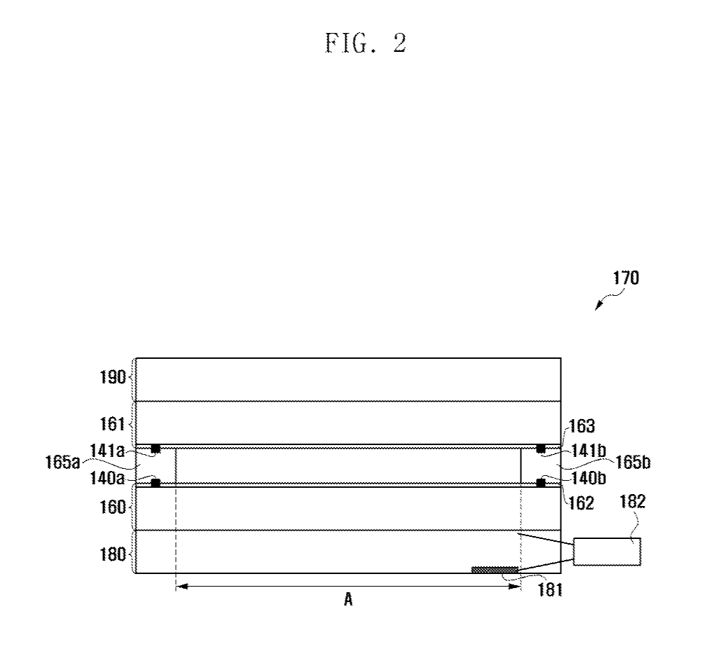

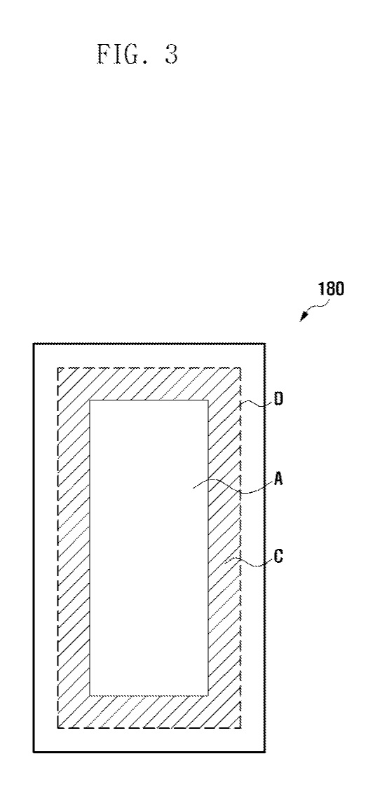

FIG. 1 illustrates a mobile device including a Touch Screen Panel (TSP) structure according to an exemplary embodiment of the present invention. FIG. 2 is a cross-sectional view taken along a dotted line B-B′ of a mobile device including a TSP structure according to an exemplary embodiment of the present invention. FIG. 3 illustrates a transparent substrate in a TSP structure of a mobile device according to an exemplary embodiment of the present invention.

Referring to FIGS. 1 to 3, the TSP structure is provided in the mobile device 100. A screen 110 of the mobile device 100 includes the TSP structure and a main Liquid Crystal Display (LCD) (not illustrated) disposed under the TSP structure. As illustrated in FIG. 2, the TSP structure includes a TSP 170 and a Light Emitting Diode (LED) 182.

The TSP 170 has a transparent substrate 180 and first and second indium tin oxide (ITO) films 160 and 161 stacked on the transparent substrate 180. The transparent substrate 180 functions as a supportable base for the TSP 170 and also protects the underlying main LCD. The transparent substrate 180 may be made of tempered glass or transparent plastic such as polycarbonate (PC), polyether sulfone (PES), triacetylcellulose (TAC), polymethylmethacrylate (PMMA), polyimide (PI), cyclic olefin copolymer (COC), and the like.

The first and second ITO films 160 and 161 are spaced apart from each other, and spacers 165a and 165b are interposed between the first and second ITO films 160 and 161. Each of the first and second ITO films 160 and 161 functions as a transparent thin film circuit and is formed of a polyethylene terephthalate (PET) layer coated with an ITO coating layer 162 and 163. The TSP 170 illustrated in FIG. 2 is a resistive overlay type. In the resistive overlay type, each of the first and second ITO films 160 and 161 functions as a resistive layer. Additionally, electrode lines 140a and 140b are formed on the ITO coating layer 162 of the first ITO film 160, and electrode lines 141a and 141b are formed on the ITO coating layer 163 of the second ITO film 161. The electrode lines 140a, 140b, 141a and 141b may be made of silver (Ag) or any other equivalent. Formed on the second ITO film 161 is an icon sheet 190 that protects the TSP 170 and displays an icon. The icon sheet 190 may be made of PET.

Formed on the lower surface of the transparent substrate 180 is an icon display source 181. If the transparent substrate 180 is made of plastic such as PC, the icon display source 181 may be formed from scratch. If the transparent substrate 180 is made of glass, the icon display source 181 may be formed by etching Alternatively, the icon display source 181 may be made of paints. As illustrated in FIGS. 2 and 3, the icon display source 181 may be located within an inner area (A) surrounded by an inner wall (D) of the spacers 165a and 165b to appear on the screen 110 without being obstructed by the spacers 165a and 165b.

The LED 182 is located near a lateral side of the transparent substrate 180. The LED 182 throws the light into the transparent substrate 180 so that the icon display source 181 can be displayed as an icon on the screen 110. The icon display source 181 may be located at a peripheral region (C), drawn as a diagonal line in FIG. 3, in the inner area (A) since the LED 182 is located near a lateral side of the transparent substrate 180. As shown in FIG. 2, the LED 182 may be adjacent to the icon display source 181.

Although the TSP of a resistive overlay type, as described above, is provided in the TSP structure, the present invention is not limited thereto. Alternatively, a TSP of a capacitive overlay type may be provided in the TSP structure.

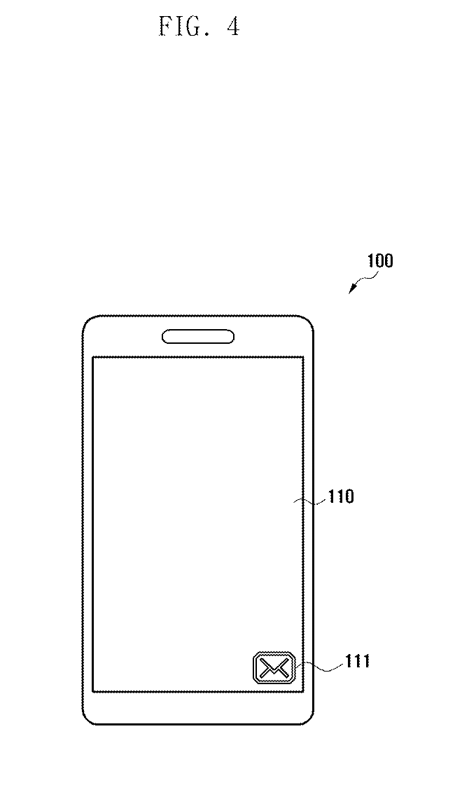

FIG. 4 illustrates an icon displayed on a screen by an operation of a TSP structure of a mobile device according to an exemplary embodiment of the present invention.

In an exemplary implementation, the icon display source 181, as illustrated in FIG. 2, may be shaped like an envelope that is correlated with a function to inform of an arrival of a received message. When a message is received in an idle state, the LED 182 is turned on and throws light into the transparent substrate 180. Then the light of the LED 182 is scattered by the icon display source 181. Here, the transparent substrate 180 functions as a waveguide sheet.

Referring to FIG. 4, an icon 111 shaped like an envelope is displayed on the screen 110 of a mobile device 100 in order to inform the arrival of a message. This function may be performed together with ringtones or vibrations.

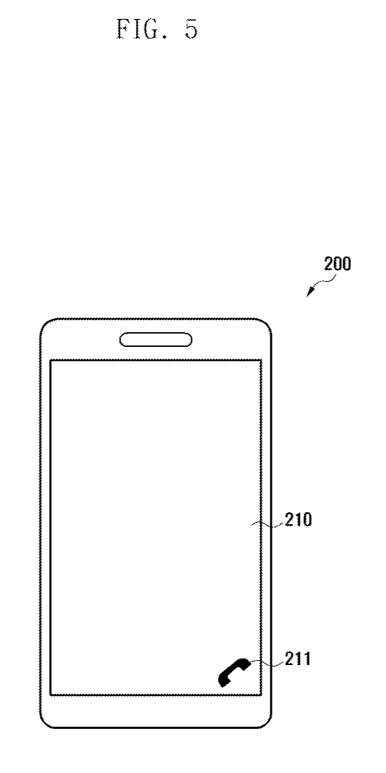

FIG. 5 illustrates an icon displayed on a screen by an operation of a TSP structure of a mobile device according to an exemplary embodiment of the present invention.

In an exemplary implementation, the an icon display source 181, as illustrated in FIG. 2, may be shaped like a phone that is correlated with a function to inform the arrival of a received call. When a call is received in an idle state, the LED 182 is turned on and throws light into the transparent substrate 180. Then the light of the LED 182 is scattered by the icon display source 181.

Referring to FIG. 5, an icon 211 shaped like a phone is displayed on the screen 210 of a mobile device 200 in order to inform of a call arrival. The icon 211 may be flickered, and the flickered function may be performed together with ringtones or vibrations.

As described above, a TSP structure of a mobile device according to exemplary embodiments of the present invention provides great advantages over a conventional TSP structure. In order to display an icon on the screen, a conventional TSP structure driving the main LCD uses a relatively greater amount of electric power, such as 150˜200 mA. However, in the exemplary embodiments of the present invention, a TSP structure driving an LED may only use a relatively smaller amount of electric power, such as about 12 mA. Therefore, the amount of electric power consumed for an icon display according to exemplary embodiments of the present invention can be reduced to below 10% of the amount of electric power consumed for the icon display according to the conventional TSP structure.

Additionally, since an LED is used for an icon display, production cost of the mobile device may be reduced in comparison with another case where an LED driving Integrated Circuit (IC) applies a voltage to respective dot LEDs to display an icon on the screen.

While this invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A touch screen panel structure of a mobile device, the structure comprising:
a touch screen panel including a transparent substrate and at least one indium tin oxide (ITO) film stacked on the transparent substrate, the transparent substrate comprising an icon display source formed on a lower surface thereof, and the ITO film comprising an electrode line formed on a lower surface or an upper surface thereof; and
a Light Emitting Diode (LED) located near a lateral side of the transparent substrate.

2. The structure of claim 1, wherein the ITO film includes a first ITO film disposed on an upper surface of the transparent substrate, and a second ITO film disposed on and spaced apart from the first ITO film, and
wherein the touch screen panel comprises a spacer interposed between the first and second ITO films.

3. The structure of claim 2, wherein the first ITO film and the second ITO film function as a transparent thin film circuit and are formed by polyethylene terephthalate (PET).

4. The structure of claim 3, further comprising an icon sheet formed on the second ITO film for protecting the touch screen panel and for displaying an icon.

5. The structure of claim 1, wherein the transparent substrate functions a supportable base for the touch screen panel and protects an underlying main Liquid Crystal Display (LCD).

6. The structure of claim 5, wherein the transparent substrate comprises transparent plastic, and wherein the icon display source is formed by scratch.

7. The structure of claim 5, wherein the transparent substrate comprises glass, and wherein the icon display source is formed by etching

8. The structure of claim 1, wherein the LED is adjacent to the icon display source.

9. The structure of claim 2, wherein the icon display source is located within an inner area surrounded by an inner wall of the spacer to appear on the screen without being obstructed by the spacer.

10. A touch screen panel structure of a mobile device, the structure comprising:
a touch screen panel including a transparent substrate and at least one indium tin oxide (ITO) film stacked on the transparent substrate, the transparent substrate comprising an icon display source formed on a lower surface thereof, and a first ITO film and a second ITO film each comprising electrode lines formed on a lower surface or an upper surface thereof;
a Light Emitting Diode (LED) located near a lateral side of the transparent substrate; and
an icon sheet formed on the second ITO film for protecting the touch screen panel and for displaying an icon.

11. The structure of claim 10, wherein the first ITO film is disposed on an upper surface of the transparent substrate, and the second ITO film disposed on and spaced apart from the first ITO film.

12. The structure of claim 11, wherein the first ITO film and the second ITO film function as a transparent thin film circuit and are formed by polyethylene terephthalate (PET).

13. The structure of claim 10, wherein the touch screen panel comprises spacers interposed between the first ITO film and the second ITO film.

14. The structure of claim 10, wherein the transparent substrate functions a supportable base for the touch screen panel and protects an underlying main Liquid Crystal Display (LCD).

15. The structure of claim 14, wherein the transparent substrate comprises transparent plastic, and the icon display source is formed from scratch.

16. The structure of claim 14, wherein the transparent substrate comprises glass, and the icon display source is formed by etching

17. The structure of claim 10, wherein the LED is adjacent to the icon display source.

18. The structure of claim 17, wherein the icon display source is located within an inner area surrounded by an inner wall of the spacers to appear on the screen without being obstructed by the spacers.
